(19) United States
(12) Patent Application Publication
(10) Pub. No.: US 2010/0191589 A1
(43) Pub. Date: Jul. 29, 2010

(54) SYSTEM AND METHOD FOR PROVIDING JOB AND BUSINESS GROWTH INCENTIVE PROGRAMS FOR AN AREA

(76) Inventor: Eldon Matte, Prince George (CA)

Correspondence Address: ANDREWS KURTH LLP, 1350 I STREET, N.W., SUITE 1100, WASHINGTON, DC, 20005, US

(21) Appl. No.: 12/691,306

(22) Filed: Jan. 21, 2010

Related U.S. Application Data
(60) Provisional application No. 61/202,053, filed on Jan. 23, 2009.

(30) Foreign Application Priority Data
Nov. 4, 2009 (CA) 2684339

(51) Int. Cl. G06Q 30/00; G06F 15/16; G06Q 20/00; G06Q 40/00; G06Q 50/00

(52) U.S. Cl. 705/14.16; 709/204

(57) ABSTRACT

An exemplary system and method are disclosed for providing a business growth incentive program. Embodiments include systems and methods for government(s) or other entities to market and promote their area, region, district, town, city, county, state, province, country, etc. (all herein referred to as “area”) to the world by using rewards and incentives, to awaken a broad entrepreneurial spirit, to mine human knowledge and to encourage all people (especially local citizens of the area) to speak positively about the area and what it offers with the goal of getting all people to use their unique talents and connections to try and bring in new people, entrepreneurs, businesses, industry, jobs, etc. for economic and other growth in the area.

### RELATED APPLICATIONS

This application claims the priority of U.S. Provisional Application, 61/202,053, entitled “System and Method for Local, Municipal, Regional, Provincial, State, National or Other Area Job and Business Growth Incentive Programs,” and filed Jan. 23, 2009, which is hereby incorporated in its entirety by reference. This application also claims the priority of Canadian Patent Application 2,684,339, entitled “System and Method for Providing Job and Business Growth Incentive Programs for an Area,” and filed Nov. 4, 2009, which is hereby incorporated in its entirety by reference.

### BACKGROUND

The Ewing Marion Kauffman Foundation's research paper entitled “WHERE WILL THE JOBS COME FROM?,” Nov. 5^{th}, 2009, has reported that, based on data from the United States Census Bureau, “it is clear that new and young companies and the entrepreneurs that create them are the engines of job creation”. Most people and governments agree that creating lasting jobs and growing their area's economy is a matter of public interest, which greatly benefits the common good because it bolsters the area government's tax revenues and improves the quality of life for its citizens (especially when done in an environmentally responsible way). Governments receive enormous revenues from property taxes, corporate taxes, personal income taxes, and sales taxes and because new jobs create new revenue streams for government in many ways both directly (e.g., income tax) and indirectly (e.g., sales tax, property tax), most levels of governments try to encourage economic growth and job creation for their area. Many governments have set up (or participate in) various kinds of taxpayer-funded initiative or economic development corporations, agencies, organizations or entities that are tasked with seeking out and attracting new investments into their area of jurisdiction. Also, many governments have developed different types of incentives, tax breaks, programs, and the like as part of their marketing efforts to attract new businesses to make investments in their area and there is increasingly stiff competition between various governments offering incentives for new business and job creation.

Current programs provide incentives for only the businesses (which may be good and necessary as well) and these incentives often amount to enormous dollars and/or breaks for a company. No programs exist to acutely motivate the common citizen with incentives or rewards to also play an active part in ushering new people, jobs and businesses into an area.

Governments spend millions upon millions of dollars to market and get the word out on all of the business incentives and positive things that their respective areas have to offer hoping to establish new business leads and connections for potential new investments. However, most marketing approaches, methods and systems used to date are not as effective as they may be at capitalizing on one of the most cost-effective forms of advertising, that is, “Word-of-Mouth” advertising. Oftentimes, the politicians and other representatives for an area may go on expensive trade missions and economic forums to other parts of the world in an attempt to make new connections, establish new leads, and to “sell” what their area has to offer for new businesses, industry, and the like. However, these “official” representatives may only do so much and they do not have anywhere near the amount of daily contact with the entire world as their area's entire population does. Many times, the results from all the area government's trade missions, marketing efforts and money spent are not as impressive as they may hope for and it is becoming an increasing challenge to find better ways to attract new business and jobs into areas.

The knowledge of potential leads and connections for new businesses and job creation that exists in the minds of the people is largely left untapped because most people are often too busy with their own affairs or it may not be worth their time and effort to speak up and provide (and/or encourage) the new business leads and connections that they may be aware of or happen to come across in their daily dealings and interactions with the world. Many people in an area may know of relatives or friends in other areas who are industrious people capable of creating new jobs or industry in the area. Everyday, people from the area (or people who know the area) travel or vacation around the world and “brush shoulders” with people from every walk of life, including CEO's and other industrious people who may be interested in expanding an existing business or looking to start a new business. Also, with everyday use of the Internet, telephone, email and all forms of communication, the area people may be communicating with other people all around the world, some of whom may be potential business people looking for new areas to expand or locate into and create jobs. Conventional devices, systems and methods have been ineffective at (and are typically not geared to) exploiting the potential new business leads that the masses of people have or encounter throughout their daily interactions with the world.

When the United States Federal Government endorsed Global Entrepreneurship Week, Nov. 16-22, 2009, it affirmed the Government's dedication to boosting entrepreneurship and ensuring “that everyone in society has an opportunity to make the most of their talents and fulfill their God-given potential.” Muhammad Yunus, Microfinance Pioneer and 2006 Nobel Laureate, has been quoted “We are all entrepreneurs. Only some of us are lucky enough to discover it.” Since it is evident that new entrepreneurs are born out of every class of people, what then is being done to purposely and meaningfully activate the entire “breeding ground” of entrepreneurs? i.e., what is an effective way to incentivize all citizens to play an active role in fostering a positive spirit of entrepreneurship and churn the “entrepreneurial pot”?

During times of negative or stagnant economic growth and decreased consumer spending federal governments may enact costly measures to try and stimulate consumer spending to boost Gross Domestic Product and save or create jobs. While these expensive measures may provide some immediate benefit to increase the GDP and help save or create some jobs, they may also appear to beg the question: Does a citizen's talent primarily exist in a “powerful and generative economic force” to consume, or does it primarily exist in a “God-given potential” to create, innovate and become an entrepreneur? Could it be true that if all citizens of an area were stimulated and encouraged en masse to play some role in fostering innovative producers and entrepreneurs throughout society, that this will lead to more economic and job growth and from there people will have more money and consumer spending will then naturally increase again to complete/invigorate the cycle?

A need exists for a new, innovative, cost effective, results-based reward system, method and tool that may help boost the morale of people and incentivize entrepreneurship, spur job creation and encourage all people to discover their “God-given potential” and use their unique talents and connections so as to be effective “ambassadors” for their area while at the same time help governments, area Economic Development Organizations (EDO) and/or agencies to efficiently gain access to the knowledge people have of new business leads in order to attract new people, entrepreneurs, businesses, industry and jobs for economic and other growth in their area.

### DESCRIPTION OF THE DRAWINGS

The detailed description may refer to the following drawings, wherein like numerals refer to like elements, and wherein:

FIG. 1 illustrates a schematic block diagram of an embodiment of a system for providing a business growth incentive program;

FIG. 2 is a flow chart illustrating an embodiment of a method for providing a business growth incentive program;

FIG. 3 illustrates an example of an advertisement to promote public involvement in a reward program that uses an embodiment of the system and method; and

FIG. 4 illustrates exemplary hardware components of a computer that may be used in connection with embodiments of a system and method for providing a business growth incentive program.

### DETAILED DESCRIPTION

Described herein are systems and methods for local, municipal, regional, county, provincial, state, country or other area job and business growth incentive programs (e.g., “reward programs”). Embodiments include a computerized system that processes knowledge and information referred by and input by participants in such reward programs, tracks actions taken and resulting from such referrals, calculates and/or provides rewards of a monetary or other nature for such actions to the referring participant(s), and other steps described or apparent from the description herein.

The term “area” as used herein means an area, region, district, village, town, city, county, state, province, or country, and/or the like. An area may be a special economic or development zone, or the like, set up by a government.

The term “government” or “government(s)” as herein used means an entity or entities responsible for governing an area, including any one or more entities that are responsible for governing the area at various levels, such as local, county, state, regional, federal, etc. These terms may include any person(s), organization(s), corporation(s), entity(ies), body(ies), and the like that are part of the government or that a government may choose to use to implement, administer, or co-operate with in the implementation and administration of, part or all of a reward program as described herein, including, without limitation, another government or governments, not-for-profit and/or for-profit entities. It is also noted that the government may not be responsible for directly governing the area that is the focus of the reward program. It is also noted that a non-governmental entity, such as a large corporation located in an area, may offer, implement and administer a reward program. In such case, the non-governmental entity may perform many of the actions described as being performed by the government below.

The term “person” may mean an individual, group of individuals, company, other entity or group of entities.

The term “company” may be a sole proprietorship, a corporation, a limited liability corporation, a partnership, an organization or similar private, public or governmental organization.

The terms “new business” or “new jobs” as herein used means any new growth (e.g., export, clean energy, manufacturing, industrial, green technology, software, residential, commercial, educational, scientific, research, institutional, agricultural, production, resource, processing, high-tech, construction, the expansion of an existing business, and the like) that a government desires to offer rewards for, to persons who are instrumental or key to attracting the desired growth to the area. The new growth does not need to be from a business, person, or entity that exists outside the area but may also come from a business, person, or entity that already exists in an area.

The “rewards” or “tips” that are referred to as being paid out or offered by the exemplary reward program as incentives need not be in the form of cash money, and may include anything or a combination of things (e.g., tax rebates for eligible participants, material prizes, or other things that an area government may use to encourage broad participation in the reward program). However, cash money may be the most obvious and broadly appealing form of a reward or tip payment to engage most people.

A “lead” or “leads” may mean any information, regarding a potential new business, new jobs or expansion of a business in an area, which may lead to the successful recruitment of the new business, new jobs or expansion of a business into or in the area. A qualified lead may also be specifically defined by the rules of a specific rewards program.

“User” or “participant” means an individual, a group of individuals, an organization, or other person that participates in a reward program as described herein. The user or participant may use embodiments described herein to submit leads, provide other input related to a reward program, receive confirmation of rewards or as otherwise described herein. The user may be a citizen of the area or not.

It is understood that the definitions herein may encompass both the singular and plural forms of the terms.

Generally, a rewards program may be implemented and sponsored by a government in order to encourage business and job growth in an area. The government may administer the rewards program and/or provide the funds for rewards paid by the rewards program. The government may appoint a particular government agency to run the rewards program. Alternatively, the government may contract with a company or other entities to administer or implement the rewards program or any part thereof.

Potential participants in the rewards program may register with the rewards program and submit a lead or leads. The registration system may also enable user accounts to be tied in to a payment system such as the user's bank accounts, Paypal™ or credit card. Financial rewards can be credited to those accounts. Likewise, fines and penalties for violating rules of the reward program may be debited from such accounts. The reward program may require registration in order for someone to participate in the reward program. The reward program may require leads to include a certain amount of information and otherwise comply with certain rules so as to avoid submission of frivolous leads. The reward program may provide a tip or small reward for a submitted lead (or it may charge participants to submit a lead, especially if frivolous lead submission were to become an issue).

The participant submitting a lead may actively participate in the recruiting of the new business or encouragement of the expansion of the existing business referenced in the lead. Alternatively, the lead may be used by government officials to recruit the new business or encourage expansion of the existing business referenced in the lead. If the new business referenced by the lead is successfully recruited or expanded in the area, the rewards program may reward the participant submitting the lead with a substantial reward. The rewards program may measure such successful results through various measures, including the opening of the new business, the purchase or lease of real property for the new business, the payment of new property taxes or payroll taxes, or other objective measures. Various other possible features of the rewards program will be apparent from the description below.

Embodiments may help lead citizens to become more informed about and aware of the importance which jobs and private enterprise are to governments and the tax revenues these generate for governments to provide public services and benefits. While any person of normal intelligence and skill may be quite capable of participating in the reward program, those who are the more “go getter,” innovative and industrious type are likely to be the ones who reap the most rewards and make the biggest difference in spurring new job creation. Embodiments may provide equal opportunities for citizens (or any person) to get involved and to be financially rewarded for being instrumental in bringing private enterprise, jobs and growth to an area.

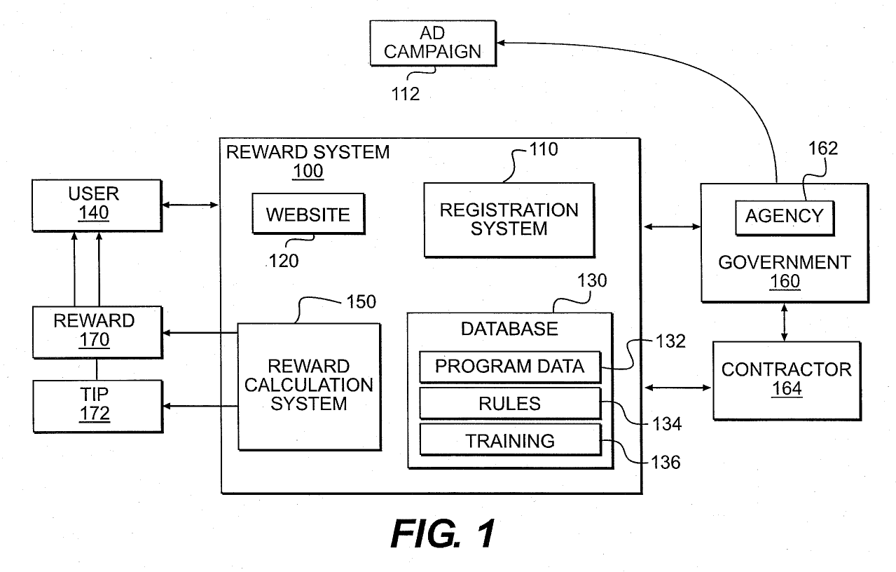

With reference now to FIG. 1, shown is an embodiment of a reward system 100 that may be used to implement and administer a reward program or programs. The reward system 100 shown is an example of a computerized system that may be used to implement a reward program or programs. One of skill in the art will recognize that a reward program may be implemented by other computerized systems or manual, non-computerized systems. Likewise, the reward system 100 and its components as shown in FIG. 1, may be implemented as software containing instructions for implementing the processes and steps described herein. The software may be resident on a computer or multiple computers connected via a network. The computers may be dedicated servers co-located or distributed at different locations. The software may be implemented as separate software modules containing instructions for performing the processes and actions described herein for each of the reward system 100 components. The components described herein, such as the registration system 110 and reward calculation system 150, may be implemented in various manners, including as multiple, separate components, or integrated into a single component. The processes and actions performed by components as described herein may be performed by other components. The reward system 100 may incorporate known technology features, such as data encryption, security measures, and the like, which are known to those of ordinary skill in the art. Described herein are embodiments of the reward system 100; one of ordinary skill in the art would understand that variations to the embodiments described herein may be made.

A feature of the reward system 100 is that it enables users 140 to participate in a reward program. Another feature of the reward system 100 is that it enables the reward program to be easily implemented and administered. Such a reward program may be sponsored by a government 160 to encourage job and business growth in an area. Such a reward system 100 may include a registration system 110 for users 140 to register with the reward system 100 so as to participate in the reward program. The reward system 100 may also include a reward calculation system 150 that monitors the development of new leads and calculates rewards 170 to be paid to the users 140 for bringing in new people, businesses and jobs to the area. The reward 170 may be sizeable cash rewards, tax credits, breaks or other tax incentives, or may be any other kind of motivational reward or incentive.

With continued reference to FIG. 1, the reward system 100 may provide a website 120 with a log-in portal for the user 140 to register with the registration system 110 and to log in to the reward system 100. The reward system 100 may also include a database 130 storing various reward program data 132, rules 134 established by the government 160 relating to the reward program, and training courses 136 that provide information on the area, businesses in the area, and industry and business incentives available for new businesses, as well as other information about the reward program. The website 120 may contain information about the reward program and about the area that may be relevant to attracting new people, businesses and jobs. Such information will enable users to become fully informed about all the positive things and government incentives that the area has to offer to any person, business, company, industry, and the like looking for an area to visit, setup or locate in and the website 120 may provide links to other websites with relevant information.

Alternatively, the reward system 100 may also include a manual filing type system that uses folders, paper, pens and other machines or mechanical devices administered at a government office so that persons desiring to participate in a reward program may learn about the details of the reward program and manually register themselves in accordance with the rules established by the government 160 sponsoring and/or administering the reward program. Some examples of things that may be required for registration may be a person's name, identification number (e.g., a social security number), address, telephone number, and email address.

In accordance with established rules 134, the registration system 110 may enable the user 140 to file, log, input and update new leads and other information that the user 140 deems relevant in its efforts to promote and attract new jobs and business to the area. The lead or leads and other information a user 140 may input into the registration system 110 may include, for example, names of a potential new businesses and of individuals in the potential new business whom the user 140 knows or is dealing with, contact information, correspondence, any documented evidence that may be relevant in determining the user 140 is responsible or key for introducing or bringing the new business to the area, a log of progress made in any of its efforts to attract new business or jobs, and other evidence that may help the user 140 to be eligible for receiving a designated reward 170.

With continuing reference to FIG. 1, the leads and other information input by the user 140 may be stored with other rewards program data 132 in the database 130. The user may elect to communicate a submitted lead to government officials in order to obtain government assistance with recruiting the new business to the area. Indeed, in an embodiment, the reward program rules 134 may require that a lead and other information be communicated to a government official. The rules 134 may also require that a government official or officials be involved in the process of securing the new business.

Alternatively, if not otherwise required, the user 140 may elect to keep the leads and other submitted information confidential. This would enable the user 140, who may happen to be the best person to pursue the potential new business, to do so without interference from government officials or others involved in the reward program. Submitting a confidential lead and other information to the rewards system 100 may establish the user's 140 “possession” of the lead and may enable the lead to qualify for the reward program. Likewise, submission of the lead, even if confidential, may enable the user 140 to qualify for a reward 170 if the lead results in the successful recruitment of a new business. When a user 140 may be eligible for a results-based reward 170, the government 160 may review the information input by the user 140 (whether it was initially confidential or not) to help verify that a reward 170 may be due and payable.

Accordingly, the reward system 100 may enable the user 140 to setup, view and update multiple files under the user registration (e.g., a file for each business it may be seeking to attract into the area). The registration system 110 may record the date and time of all information input by the user. Likewise, the registration system 110 may automatically log all activity a user has in the reward system 100. As noted above, if permitted by the rules 134 established by the government 160, the information input by the user 140 may only be accessible by the user 140 who supplied it or, in the alternative or as elected by the user 140, the information may be accessible also by those whom the government 160 has authorized. Likewise, access by the government 160 may be limited to certain members of the government 160, if permitted by the rules 134.

With continued reference to FIG. 1, the registration system 110 may send a form of an acknowledgment receipt to the user 140 for any data entered into the registration system 110 (e.g., an acknowledgment email with reference to a file number and data received). The registration system 110 may also send a message to a government agency 162 established by the area government 160 informing it of new users 140 or the new data inputted into the registration system 110 by a user 140. The registration system 110 may also include a device (such as a computer or server) for people to access and self register within a government office so that government personnel may assist them in registration and input of data and new business leads.

An embodiment may include a module or other means (not shown) for receiving and filing new business leads and registration information using email and other forms of communication. Communications may take place when there is a new registration, a new lead filed, and any other relevant activity that needs to be brought to the attention of the government 160, agency 162 or other entity administering the rewards program. This may take place using information being sent by the registration system 110 to the agency 162 (e.g., using email) or an official of the agency 162 accessing the registration system 110 and the registration system 110 displaying the new business lead, system activity, and/or data on a screen for viewing, printing, or other use, and the like.

Embodiments of the reward system 100 may encourage the user 140 to take an active role in following up on any new business leads that the user submits. The greater success achieved at recruiting a new business to an area, the higher reward 170 a user may receive. The reward 170 may be interpreted as a type of a “business bounty” that may give rise to a new kind of “business bounty hunter” industry. Such “business bounty hunters” may be users that regularly submit leads and actively pursue the recruitment of new businesses. It is conceivable that this new “industry” may itself potentially spawn new jobs that will be paid for by new private “business bounty hunter” enterprises.

In some instances, a new business that locates to the area may play a useful role in helping to identify the first or key person responsible for their “recruitment” to the area. Such an identified person may be the user who is deserving of the reward offered by the government 160. For example, the key person may be the person that drew the business's initial attention to the area as a possible place into which the business would locate or expand. The business may indicate that if it were not for that person's initial efforts, the business may not have located to or expanded in the area.

As indicated above, an embodiment may include a set of rules 134 to govern the reward program, define rewards 170 (which may include tips 172) and to otherwise provide reasonable checks and balances, to ensure fairness, ethical conduct and to avoid conflicts of interests. The rules 134 may be implemented as regulations enacted by a government agency 162 administering the program and/or set forth in law propagated by the government 160. Each area government 160 and/or agency 162 implementing a reward program(s) may devise, adopt or revise rules 134 that best suit the relevant area's needs, principles and priorities. Such rules 134 may likely include, without limitation:
A definition of the rewards that will be paid out, the amounts of the rewards, and what the reward structure may be for the area for example, whether more emphasis is placed on the creation of primary industry and jobs (e.g., export factory, mill, manufacturing, mining, software development, hi-tech, and the like) by offering larger rewards for primary industries than for secondary industries (e.g., retail, personal service, medical, dental, and the like) because secondary industry and jobs tend to naturally and more automatically follow when there is an influx of primary industry type jobs in an area; or as another example, a government 160 may wish to place higher rewards for the creation of what they may consider “environmentally friendly” or “green” jobs, or as another example, the government 160 may structure the rewards to directly correlate to the amount of benefit or revenues the area government 160 receives from the new business and/or new jobs, be it income tax revenue, property tax, sales tax, increased exports, and the like; as another example, the rewards may be for only the “full-time” jobs created or on jobs that pay over a certain wage or salary level; or, as another example, the area government 160 may structure the rewards based on any combination of these or other things, depending on what their priorities are for their area, and the like;
Whether there may be bonus rewards for attracting new business or jobs to a smaller area within the larger area, i.e., where the government 160 may like to see more development or redevelopment occurring (e.g., a lot of cities struggle to keep their downtown area vibrant and may want to offer an even bigger bonus reward to a person who is key to attracting new businesses and jobs into the downtown area of the city, or, for example, it may be wise for a federal or state government(s) to offer higher rewards for job creation in regional areas, counties or cities that need more diversification or that are plagued with higher unemployment and perhaps smaller or no rewards to areas that are well diversified or where job creation is healthy);
Whether the payment of a reward to a user 140 may be publicly announced in advance (e.g., 30 or 60 days in advance) to bring more public awareness to the reward program (e.g., similar to how lottery corporations may advertise their winners) and also to give time for anyone who may have a legitimate objection or claim to the reward to notify the government 160;
How “results” may be defined (for example, a government 160 may define results in any number or combination of ways, such as: a) numbers and types of new jobs created, b) amount of new property tax paid by a new business, c) amount of personal income tax collected from the new jobs created, d) amount of corporate income tax collected from the new business, e) the number of years the business operates, f) the environmental impacts a new business has);
Whether or not the government 160 desires to pay out any tips 172 to people who submit qualifying “leads”;
What constitutes a “lead”; for example, a government 160 may define a lead that is eligible for the tip 172 as information on a company and/or person seriously looking for an area to grow or startup in and whom shows serious interest in the area (as evidenced by the company's serious inquiries and correspondence with the government 160 about the company's growth or expansion plans) and with whom the government 160 had not already been in recent discussions;
How a person may need to register in the reward program before they may lay a claim to a reward 170 and whether or not the person needs to agree (electronically or manually) to certain terms and conditions established by the government 160, as part of the rules 134, before the person may be eligible to participate and receive a reward [e.g., the agreement may include without limitation: a) the government 160 reserving the right to change the reward program rules 134 or rewards 170 or cancel the reward program at any time (with perhaps some advance notice) b) stipulations as to how the area government 160 may use “lead” information submitted for attracting the new business, c) requirements that users 140 promise to truthfully represent the area, d) how a government 160 may disqualify a user 140, e) having users 140 agree to the reward 170 being paid to an “interpleader” if there happens to be a dispute arising between users 140 or others trying to lay claim to the same reward—there should be no further cost to the area government 160 in this event, f) the user 140 consenting to the area government 160 using their names in advertising and promotion of the reward program if they are paid a “results-based” reward, g) privacy policies, h) whether a user account may need to be tied in to some kind of payment system with their bank-account or credit card or PayPal™, etc., i) whether a user violation of the rules may be subject to a user being fined and their accounts may be debited by the government, j) other terms and conditions to limit any risk to the government 160 and to minimize any possibility for the reward program to be abused];
Outlining who may not be eligible to claim a reward (e.g., the government may limit the eligibility of those directly involved with dispersing any reward 170 or tip 172 or administering the reward program; or, for example, eligibility may be further limited to only those who reside in the area, or it may be open to all persons both in or outside the area, and the like). Eligibility rules similar to those typically used in sweepstakes, lotteries or other contests may apply;
When the reward 170 may be paid out (e.g., a government 160 may choose to not pay out a reward until at least a year after results are realized or perhaps at varying intervals like one year after results are realized, a small part of the reward is paid out; and after five years of realized results, the larger part of the reward is paid out because most new businesses either succeed or fail within five years; or, for example, a government 160 may pay out a partial reward every year over a number of years, and the like). There may be many factors to take into consideration in deciding when the reward 170 is paid, one of which may be the impact this may have on participation in the reward program;
Whether or not the reward 170 should be split amongst more than one person who may have been instrumental in attracting the same new business or to reward it to just the key person who first put the area “on the map” or “on the radar” for the new business in its quest for an area to locate or grow in, or if there is a dispute that the government 160 cannot resolve amicably, to pay the reward into a court (or hold it in escrow) while the persons argue the matter between themselves before a judge or arbitrator;
Whether a reward or tip paid out is susceptible to income tax, i.e. if the reward 170 or tip 172 paid out does not have to be claimed as part of a person's income, it may increase the incentive for persons to participate in the reward program, (e.g., similar to lottery winnings in Canada, which may not be subject to income tax, the US 2009 Cash for Clunkers vouchers, which were not subject to income tax, or other government program payments which are not subject to income tax). Note: local or civic governments may not have much control over a rule like this unless there is cooperation from other levels of government;
Whether or not a person may claim a reward for initiating and setting up their own business that creates new jobs in the area (e.g., a government 160 may make a rule that may allow a local resident entrepreneur of the area to register and submit a new business lead on herself and be eligible to claim a reward but have a requirement so that new business leads submitted on new businesses from outside may need to be submitted by a person who is not an owner of that new business; or for example, the reward may simply be open to any entrepreneur to submit a lead on themselves or simply have it that no one may submit a lead on themselves, and the like). Allowing persons to submit a new business lead on themselves may have a negative impact on: a) how effective and attractive the reward program is at encouraging broad participation and fostering a broad entrepreneurial spirit, b) getting new business leads, c) word-of-mouth advertising for the reward program and d) use of the reward program as an aid for boosting the morale of the people; these may be some of the many influencing factors for the area government 160 to take into consideration in deciding on a rule for this;
There may be a rule that specifies that participants 140 may not have any ownership interest (or any pending/intended ownership) of a company referenced in a new business lead submitted by a participant 140. Such a rule, however, may (depending on parameters that may be established within the rule) permit a participant to acquire some or all ownership of a company referenced in the lead after they have submitted the lead. This type of a rule may have the positive effect in some instances of fostering new dynamic partnerships or ownerships to create new jobs (e.g., a participant 140 may be able to leverage potential pending or anticipated future reward money 170 to “buy” into a company and help the company be successful at maximizing an opportunity(s) the participant 140 may see for producing additional company profits through new job creation) or it may have the effect of fostering a positive takeover by a participant 140 of a company that may have a lot of potential but the current owner(s) may not agree or see the opportunity(s) or new potential company profits that the participant 140 may see in creating new jobs in an area.
For a variety of reasons including fostering extra public involvement, dynamic partnerships and better entrepreneurship, a government may deem it beneficial to encourage participants to register and work in teams of two or more people by offering, for example, double rewards for jobs that come from new business leads submitted by a registered team than if it was submitted by just one person.
A dispute resolution mechanism that must be agreed to for a user to participate in the reward program. For example, the rules may specify an alternative dispute resolution mechanism that specifies a user must submit any dispute, such as claims that the user is entitled to a reward or a larger reward, to an independent arbitrator or mediator;
Rules regarding how area Economic Development Organizations/contractors 164 may register with the government and the reward program to potentially receive leads from the system and/or may otherwise be involved with or participate in the reward program; and
Other rules that would specify how the reward program functions, and the like.

While the above rules 134 have been described as being enacted by a government, a contractor 164, such as a corporation or other entity, may be set up by a government in order to implement and/or administer the reward program and/or the reward system 100 described herein. If a contractor 164 implements and/or administers the reward program, the rules 134 may be set by the contractor 164 for users 140 in the reward program. The contractor 164 may receive revenue under a government contract, be paid a percentage of rewards paid, or tax benefits or fees received from new companies located to the area through the reward program, for example.

With continuing reference to FIG. 1, the rewards 170 (e.g., cash or other monetary reward) may be sizeable and attractive enough to encourage almost anyone (poor or rich) to try to bring about the desired results that the government 160 is looking for in adopting the reward program. While the reward 170 may be a substantial amount for an individual to receive, the reward may be nominal for a government 160 when compared to the overall benefits the area receives and the revenue that the government 160 may collect in taxes from the new businesses and jobs created in the area.

In deciding who should receive the reward, the reward system 100 may employ principles and criteria similar to those that organizations like “Crime Stoppers” use to determine who receives a reward for submitting information that leads to the arrest of a criminal. For example, if two or more users submit a lead for the same business, such principles or criteria may determine which of the persons is entitled to the reward based on which user's lead most directly led to the new or expanded business or which user did the most to secure the new or expanded business. Some of the relevant principles used by patent offices to issue patents, e.g., first person to file, could also be adapted to aid in deciding who receives a reward.

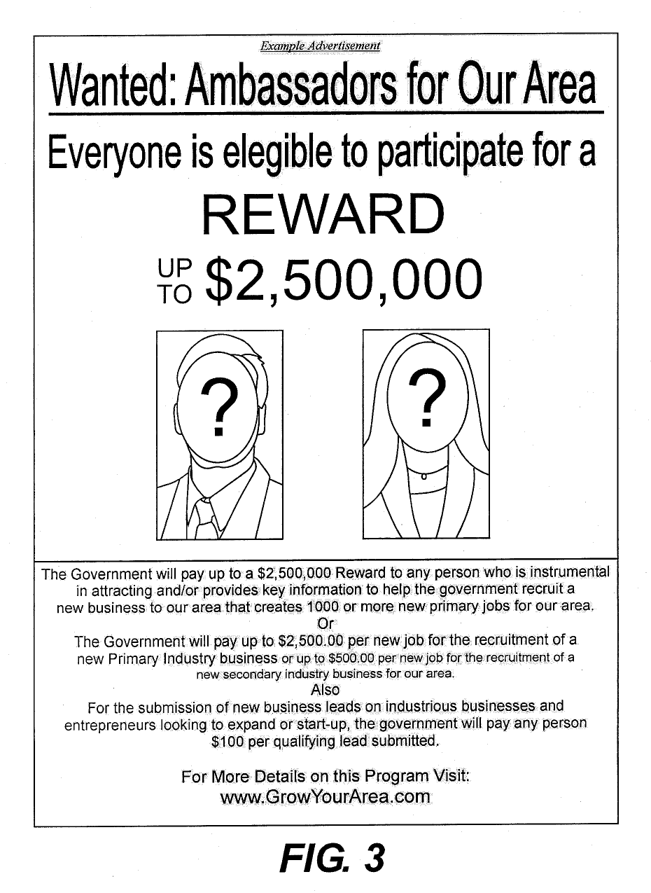

Start-up advertising costs for the reward program may be almost nil as the citizens 140 may gain broad understanding through news coverage and word-of-mouth. This may be especially true if the reward program undergoes effective debate and discussion in the government 160 before passing legislation to implement the reward program for an area. News coverage may then be followed up with perhaps a series of catchy “Wanted” and “Reward” type advertisements [e.g., see FIG. 3] through various mediums to continually keep “top of mind” awareness of the reward program.

An embodiment may include an advertising campaign 112 to spread the word in and outside the area about the reward program and rewards 170 (which may include tips 172) available to any person that provides leads on potential new businesses and job creation for the area. The advertising campaign may encourage everyone to get involved and become informed. Print advertisements may be through newspapers, magazines, direct mail, community bulletin boards, and the like. All forms of communication and advertising throughout the internet may be used including Google™, Yahoo™, social networking sites, universities, online gaming advertisements, and the like (perhaps another example for a catchy advertisement may be a “Reward” or “Wanted” type of advertisement done as a pun on the old law enforcement advertisements except the pictures of the “outlaws” in the advertisement may be pictures of famous entrepreneurs and business people before they ventured off on their own to establish a new business (e.g., Bill Gates or other popular Fortune 500 CEO's, and the like). The advertisement campaign 112 may use all available means of advertising, including television, radio, Internet, etc., with catchy advertisements [e.g., see example in FIG. 3] to engage as many persons as possible and to direct them to a website 120 that may provide more information on the rewards 170, the reward program and how to register and get involved. Appropriate follow-up “top of mind awareness” media engagement (and advertising) may generate a significant amount of ongoing “water cooler” and “kitchen table” discussion, general excitement and “buzz” all across an area to foster a broad entrepreneurial spirit and stimulate the actions and thinking of many people to investigate the possibilities being offered by the reward program which may incidentally lead some people to become an entrepreneur after discovering what an area government offers for incentives to new business, the various attractive opportunities that may exist in an area, etc.

Potential spin-off effects for the reward program to incidentally (purposely or not) spur and activate new entrepreneurs may be very significant depending on a) the specific rules 134 established by the government 160, b) the structure of the rewards 170 (and/or tips 172), c) how the government runs the program generally, d) the effectiveness of the website 120 (e.g., containing very good, succinct and complete information on various government incentives for new businesses, attractive new business opportunities for an area, etc.), e) the effectiveness of the ad campaign, and f) other factors. Potential desirable “spin-off” effects (e.g. a user deciding to start their own new business and create new jobs in an area) may be substantially and deliberately enhanced if, when the government 160 adopts rules 134 and otherwise properly implements the reward program, the government 160 bears in mind the potential that may exist for desired spin-off benefits and effects.

With continuing reference to FIG. 1, the website 120 may provide users 140 all the information, resources and training that may be applicable to the reward program. The website 120 may also include helpful information for attracting new businesses, industry, people and jobs to the area and promote all that the area has to offer for businesses [e.g. succinct info on the various business incentives that may be offered by every level of government for the area]. The website 120 may have a publicly accessible portion that any member of the public may access, not just registered users 140. The helpful information about the area may be available in the publicly accessible portion, as well as information about the reward program. In this manner, the website 120 may encourage members of the public to register with the reward system 100 and become users 140. The website 120 may be comprised of multiple websites [e.g. a specific site for each sub-area (e.g. state, county, city, etc) that is participating in a reward program that may be offered by a larger area (e.g. country, state, etc.]. The website 120 may contain links to any other relevant websites [e.g. a website for an area Economic Development Organization or websites with practical economic development tools and data] or agencies that may assist in helping new business into an area.

The website 120 may also include third-party advertising that provides an additional source of revenue for the reward program. The third-party advertising may be related to businesses in the area or not. The revenue from the third-party advertising may be used to fund or partially fund the rewards 170 and tips 172 paid out to users 140.

The government 160 may provide brochures or business or other small cards that may constitute a little “cheat sheet” listing incentives and positive things that the area has to offer in attracting new business, new jobs or new people into the area and reference a website or where to get additional information. These brochures or business cards may be updated and sent out often to people of the area so they have a copy handy in the event an opportunity arises for them to promote their area to a potential new business and to develop a new lead. Informational emails or other forms of communications may also be sent out regularly to users 140 and others who wish to receive the latest information on the area or other information the government 160 wishes to distribute to keep users 140 informed and engaged in the reward program, including any changes to the rules 134 that the government may make. Users 140 may likely develop their own creative ways to promote the area and get new leads. For example, users 140 may develop their own specially made cards, like a business contact card with information to promote the area, to hand out to persons, entrepreneurs and businesses who may be potential new business leads for the user 140 to input into the system, and the like.

Rewards 170 may be paid out from a government's general revenue source. However, if a reward is paid out as a “results-based” reward, the reward may amount to merely a small amount compared to the benefit in new tax revenue and other benefits that the area and government may have already received. So in essence, even if a sizeable “results-based” reward is offered, the government 160 may have a net gain with the new business and jobs being established rather than not being established. Alternatively, the reward 170 may be paid out of revenues of a contractor 164 hired by the area government 160 to run the reward program.

In an embodiment, the reward system 100 may include a reward calculation system 150 that may calculate whether and when a reward should be paid to a user and what amount of a reward may be paid. The reward calculation system 150 may be integrated with other existing government systems to monitor and track data (e.g., business licenses, company payroll records, corporate tax records, property tax records, income tax records, and the like) and other parameters that the government 160 has set to govern rewards. By being integrated with other systems, the reward calculation system 150 may be configured so as to automatically receive necessary information to calculate and administer the payment of rewards 170. For example, if a reward structure is based on the number of jobs a new or expanded business produces and the income tax collected from those jobs, the reward calculation system 150 may be integrated with a government payroll tax system and may monitor and track the number of persons on the new company's payroll and the payroll tax revenue received through the payroll tax system. Through the information received from the payroll tax system, the reward calculation system 150 may determine the rewards 170 to be paid out, if any. Likewise, if the rewards 170 are based on additional property tax collected from the location of the new business, then the reward calculation system 150 may be integrated with the government's property tax system and may monitor and track property tax collection data through the property tax system. Through the information received from the property tax system, the reward calculation system 150 may determine the rewards 170 to be paid out, if any. Similarly, the reward calculation system 150 may be integrated with other computer or data systems of the governments 160 that hold information relevant to the calculation of rewards 170.

Alternatively, the relevant data for determining and calculating rewards may be input manually into the reward calculation system 150 by a “system user.” A system user may be an individual authorized to access the reward system 100, and the data contained therein, by the government 160 or other entity administering the reward program. The system user may receive reward claims submitted by a user 140 or otherwise communicated by the reward system 100 and may investigate relevant information to determine whether a reward 170 should be paid. The actual reward to be paid may also be manually calculated, rather than calculated by the reward calculation system 150. Moreover, even if the reward calculation system 150 determines and calculates the reward 170, a system user may review and approve of the reward 170 prior to payment. The system user may present rewards 170 for approval to the government 160, the government agency 162 or contractor 164 implementing the reward program.

Approved rewards 170 to be paid out may be paid out in ordinary manners. For example, the reward 170 may be wired or direct deposited to a participant's bank account, or a cheque may be cut and sent to the user. The reward calculation system 150 may be integrated with a bank account set up to provide the funds for the rewards 170 and may direct the electronic payment of the reward 170. Alternatively, the actual payment of the rewards 170 may be done manually.

In an embodiment, the reward program may be administered by a contractor 164, such as area development corporations or other similar entities, that many areas already have in place to attract and to assist new businesses and job creation. In most cases, the costs for promotional advertising needed to engage the public in the reward program may be covered within existing budgets by simply redirecting some of the dollars being spent on less effective marketing strategies. If the rules 134 specify that a reward 170 is paid out only after concrete results and benefits are realized by the government 160, then the government 160 should have no financial difficulty paying out the reward 170. As mentioned above, rewards 170 may be large enough to be significant to an individual but only nominal to the government 160 in comparison to the results and benefits received for government revenues and the common good. [Note: A properly designed “results-based” rewards structure may also, by its very nature, inherently and significantly reduce the chances of abuse by an unscrupulous user]

The following is an example of a reward structure for a reward program for an area. Virtually unlimited varieties of reward structures may be imagined and implemented for a reward program.

If, after a first year in which a new business license was issued by the government 160, the business size is as follows, the following rewards 170 may be paid out under the reward program (e.g., by reward system 100):

| Business Size | | | Downtown |
|---|---|---|---|
| (in jobs) | | Reward | Bonus Reward |
| 1-10 | jobs | $1,000.00 | $500.00 |
| 10-50 | | $5,000.00 | $2500.00 |
| 50-100 | | $10,000.00 | $5000.00 |
| 100-200 | | $50,000.00 | $25,000.00 |
| 200-400 | | $75,000.00 | $40,000.00 |
| 400-1000 | | $100,000.00 | $50,000.00 |
| 1000+ | | $150,000.00 | $75,000.00 |

As seen above, the reward program may also include special additional rewards for businesses that locate in a sub-section of the area, such as a downtown area of a city.

If same above business is still in business after five years, additional rewards 170 may be paid for corresponding business sizes as follows:

| Business Size | | | Downtown |
|---|---|---|---|
| (in jobs) | | Reward | Bonus Reward |
| 3-10 | jobs | $5,000.00 | $2,500.00 |
| 10-50 | | $20,000.00 | $10,000.00 |
| 50-100 | | $50,000.00 | $25,000.00 |
| 100-200 | | $100,000.00 | $50,000.00 |
| 200-400 | | $200,000.00 | $100,000.00 |
| 400-1000 | | $450,000.00 | $225,000.00 |
| 1000+ | | $1,000,000.00 | $500,000.00 |

Another example of a reward structure for a reward program may be a straight flat rate per job created, but with a much higher reward rate for primary industry job creation (e.g., because the secondary industry jobs may naturally follow if there is a large increase in primary industry jobs). For example, primary industry job rewards may be at, for example, $200/job after the first year of operation and $1000/job after 5th year of operation. Secondary industry job rewards may be, at say, $100/job after the first year of operation and $400/job after 5th year of operation (or perhaps an area government 160 may not offer any rewards for secondary job creation and just focus on offering even higher and more attractive rewards for the primary industry job creation, for example, manufacturing). Also, since it is known that new firms are an overwhelming source of new job creation, it may be advantageous to focus extra rewards for the establishment of new firms. The possibilities for structuring the rewards 170 may ultimately be as varied as the people and areas themselves and may emphasize or de-emphasize just about anything or any type of business or job creation as desired by the government 160 (e.g., environment may also have a role on the types of jobs that are to be given higher rewards for, and the like). Also, an important consideration regarding results-based rewards paid out over a period of say 1 to 10 years after new business/jobs are created is that it may provide a stimulus for participants to inherently think long-term and spend their time and effort to attract only long-lasting and sustainable business investments to the area because there may be little or no benefit or reward for recruiting short-term “fly-by-night” businesses or unscrupulous companies to come to the area.

Considering the US Government decision in 2009 to expend $74 billion to protect 240,000 existing auto industry (primary industry) jobs (which amounts to $308,000 per job) or considering the US $787 billion stimulus bill passed in 2009 to “save or create 3.6 million jobs” (i.e. $218,611 per job) it may be evident that the reward examples for the establishment of new primary industry jobs may even be significantly more than shown. In fact, it may be wise and very advantageous during economic downturns or times of difficult high unemployment rates to make the “results-based” rewards for primary jobs extremely attractive for the first few months (or years) in order to provide a maximum stimulus to get most people from all socio-economic classes interested, involved and talking positively to turn things around. For example during a time of high national unemployment rates, a federal government may offer (e.g., for 6 or 12 months) a flat reward of say $10,000 per new primary job created anywhere in the country ($1000 per new secondary job created) and in specified local areas or counties where the unemployment rate is 8-15% the rewards may be doubled and in specified local areas where unemployment rates are above 15% the rewards may be tripled. The results-based rewards may be paid out incrementally over a number of years as may be determined appropriate and affordable by the Federal Government. Once the morale of the people has turned more positive, a broad entrepreneurial spirit has been established, people are more knowledgeable of the various programs and business incentives available to help entrepreneurs to grow new jobs, unemployment rates fall, etc, the government may reduce the rewards being offered to lesser amounts. For example, after the first 6 or 12 months of rising/high unemployment the rewards may automatically drop to amounts predetermined by a Federal Government to be more appropriate for the long term purposes of the program (e.g., depending on the national unemployment rate there may be “interim high rewards” and “standard level rewards” predetermined by a Federal Government). Alternatively, the Federal Government may lower the rewards for just certain types of primary job growth after an interim period and keep them elevated for spurring specific types of job growth that it may want people to focus more heavily on and put more effort into fostering (e.g., green jobs, export jobs, etc.). Also, as an additional measure to increase the stimulus and interest in one's local area, lower levels of government (e.g., cities, counties or states with higher unemployment rates) may be allowed (e.g., with permission from a Federal Government in a federally implemented reward program) to offer additional rewards to those being offered by a senior level of government.

A possible feature that may help to encourage broader public engagement and participation is a method of paying out a nominal tip 172 to persons who submit leads to the reward program. Tips 172 may be calculated and paid in a manner similar to rewards 170, as described above. The reward calculation system 150 may determine and calculate the payment of tips 172. The rules 134 should specify the requirements for a lead that qualifies for a tip 172. The system 100 and program rules 134 should include necessary checks and balances so as to minimize frivolous leads and wasteful payments of tips 172.

An example for an innovative and potentially mind stimulating rule that may be established during the first few months after the launch of the reward program to: 1) immediately and meaningfully engage people's minds to help spur the creation of new jobs, 2) boost morale and entrepreneurial spirit and 3) to stimulate massive public discussion, may be to offer to pay, for example, all newly registered users 140 a nominal $100 (or even a $500) tip payment 172 for having submitted their first new business lead. The government 160 may place a cap on the total tip money that may be paid out during the first few months of the program. This would provide an immediate incentive for people to start: 1) learning about the reward program, 2) thinking about potential new jobs and new business for their area, 3) learning about their area and all the various existing incentives that governments and other entities offer to new entrepreneurs and businesses to establish jobs in the area and 4) ponder and discern a new business lead that they may enter into the system 100 to qualify for a “first-time user” tip payment 172 (and eventually a results-based reward 170 if the lead ends up being key to the establishment of new jobs). For a user's 140 first lead submission to qualify for the tip payment 172, the user may be required to fill in a web form field that may require the user 140 to write a concise description [e.g., 400-800 words] about why they think the new business lead that they are submitting could come to fruition in the area, the types (and numbers) of jobs that may be created and to succinctly identify a certain number of government business incentives/programs (or incentives/programs offered by other entities) that the user 140 believes the new business may be eligible for and how the new business may apply for these business incentive programs. An additional qualifying factor may require the user 140 to fill in another field and write [e.g., 200-800 words] on at least one “stumbling block” that the user foresees which may prevent the specified jobs from being created, as well as a suggestion of how the “stumbling block(s)” might be overcome. The rules 134 may stipulate and require that a person 140 only be allowed to register once in the system 100 to receive a “first lead” tip payment 172 [e.g., a person 140 may need to use their social security number and a personal bank account to register as this may reduce the possibility of someone registering as a user twice to unlawfully receive more than one “first tip payment” 172]. The “first lead” submissions may be verified by government personnel to ensure that they meet qualifying criterion and then payment 172 may be authorized by direct deposit to the bank account that was supplied by the user 140 at registration [e.g., this may be similar to how the government authorizes personnel to pay unemployment benefits to eligible applicants, or similar to how government may typically qualify a person to receive any kind of payment from the government]. A “first lead” tip payment 172 offering may be for a limited time (e.g., for the first 60 days after the system 100 launch). After the time limited period, the government 160 may re-assess the effectiveness of having offered tips 172 for leads and decide if it ought to continue offering tips 172. If tips 172 are to be continued, the government 160 may determine if there needs to be any adjustments to the rules 134 for paying out a tip 172.

In lieu of offering a tip payment 172, an additional innovative option for a government 160 to cost effectively leverage existing expenditures and engage extra people to participate in the reward program may be to ask those receiving financial assistance from the government (e.g., unemployment benefits, welfare, food stamps, social security, and the like) to become informed about the rewards program and request that they voluntarily submit leads or ideas for new jobs into the system. For example, if the government 160 deemed it to be appropriate and believes that it may not be too burdensome to ask jobless people for some “thought-provoking” help, the government may request voluntary participation of all people relying on unemployment benefits to submit at least one or more new business lead (or at least some type of an idea for new jobs) prior to claiming or receiving benefits. Knowledge may have the ability to empower a person. By encouraging many jobless people to use some of their time to learn more about: 1) the reward program, 2) all the positive things their area may offer, 3) the various government incentives offered to new and potential entrepreneurs to spur new business and job growth, 4) and the like, this may provide considerable positive intellectual stimulation in the minds of out-of-work individuals and may inspire them to do more to try and help solve their own unemployment problems along with many of their fellow citizens. In this way, the government 160 may be helping many jobless people discover the “entrepreneur within” themselves and may also be providing them with an occasion to ascertain “an opportunity to make the most of their talents and fulfill their God-given potential.” All people receiving government benefits, including those with disabilities or handicaps, may be encouraged to participate and provide ideas or new leads for new business and job creation. A government agent 162 or contractor 164 may be required to assist those people who may need help to compile or submit a lead or job creation idea into the system 100 (e.g., charitable assistance for a physically disabled person, an illiterate person, etc.) If, after a period of time, voluntary participation by people receiving government benefits turned out to be low or insufficient or for any other appropriate reason, the government 160 may decide to make it mandatory that all “capable” people submit a lead or an idea for a new business or new job creation in their area prior to claiming or receiving unemployment benefits, welfare, food stamps, etc. Obviously if lead submission was made mandatory for those on government benefits, there clearly would need to be compassionate exemptions for people who may be incapable of coming up with an idea for a lead or new job creation (e.g., due to mental incapacity, etc.). Also, the general criterion for a qualifying lead or idea may not be too onerous (i.e., so as to not prevent people from receiving needed government assistance. In a mandatory situation, the government 160 may only wish to lightly encourage a person to begin the process of thinking about some small way that they perhaps may be able use their own unique talents and creativity and produce a lead or idea for new business or jobs which can be submitted into the system 100 to potentially help the government 160 reduce joblessness). Qualifying “lead” or “idea” submission requirements to receive government benefits may be the same or similar to those the government 160 has set for awarding a “tip payment” 172 (e.g., as mentioned earlier, qualifying elements may include writing a minimum number of words for the submission plus describing various incentives offered to entrepreneurs, potential stumbling blocks, etc.). Likewise, a reward program that only provides rewards for qualifying leads and does not track and provide rewards for those qualifying leads becoming new businesses or new jobs may be implemented. Note: a mandatory requirement may not be necessary in any event because the prospect for an individual to receive potentially large results-based rewards may automatically incentivize a majority of those receiving government benefits to want to participate and invest some of their time and effort to gain the knowledge needed to submit good potential leads into the system 100.

Even if few or no rewards 170 are paid out to any citizen 140 for bringing in a new business, the reward program 132 may help improve the general morale of the citizens 140 of the area because the potential for financial rewards provides incentives for citizens 140 to take time to educate themselves and be well-versed on the positive things their area offers and people may tend to naturally think and say more positive things than negative when discussing their area (e.g., just as area politicians and official ambassadors may continually increase their knowledge of all the positive things that their respective areas offer in order to better represent and promote their area as they live their lives and perform their daily duties). Also, in the process of participating in the reward program, the new knowledge gained by many citizens and participants may stimulate an attitude of broad entrepreneurship and cause many to perhaps start their own business and create jobs themselves, especially if they become convinced of a good opportunity in an area, but were unsuccessful at convincing someone else to do the business and create the jobs.

Accordingly, the rules 134 preferably are kept as simple as possible for everyone to understand and not be overly cumbersome so as to encourage broad participation from the public, including all socio-economic classes of the public. If there is broad participation, this may go a long way to boosting the morale and entrepreneurial spirit of the people as more people may be thinking and communicating very positively to the world about their own area. The reward program may also help to enhance the positive approach of many policymakers and public servants, across all levels of government, in fulfilling their mandate to assist with ushering new entrepreneurs, businesses and jobs into an area and it may enhance the positive attitudes of many professionals and people across all occupational groups in the private sector (e.g., banking, financial, business, unions, manufacturing, service, export, educational, science, engineering, students, etc.).

Once area citizens are engaged in the reward program, the reward program and citizens' involvement may help shine a positive light on the area globally as these citizens travel, visit and vacation abroad and engage in conversation with people who may have never heard of or considered their area before. Many of these people may be budding entrepreneurs or interested business people, or know a business looking to expand or relocate, or may know a potential entrepreneur who is looking for an opportunity to start a new endeavor somewhere.

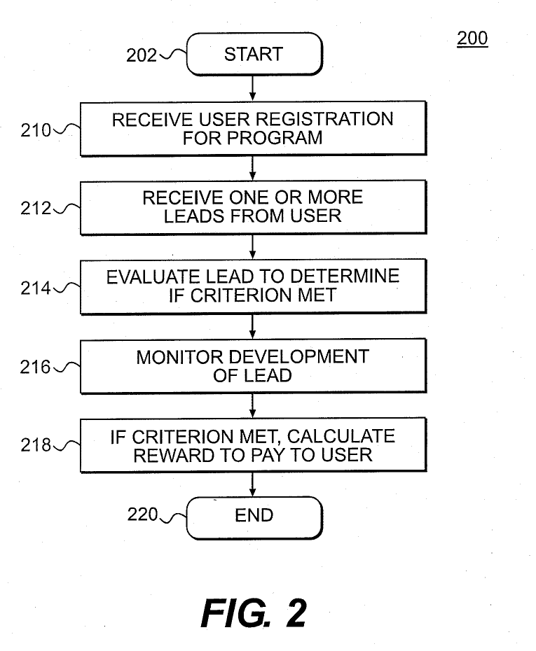

With reference now to FIG. 2, shown is a flow chart illustrating an embodiment of a method 200 for providing a business growth incentive program (a reward program). The method 200 starts (block 202) and receives a user registration for the business growth incentive program (block 210). The user registration may be received through a website, such as website 120, or other electronic means. The registration may be received and processed by a registration system, such as registration system 110 above. As indicated above, the user may access the website and submit necessary registration information in order to register and participate in the reward program. The user may have learned about the website and the reward program through advertising, word of mouth or other means. The website may allow the user to access information about the business growth incentive program, area incentives and programs to attract new business and new jobs, and general information relevant to the business growth incentive program. Alternatively, the user may register in person at a government or other office that is responsible for administering the reward program. The method 200 may include sending an acknowledgement of receipt after receiving registration information from the user and the user's successful registration.

The method 200 may receive from the user one or more new leads for potential new businesses or expansion of existing businesses for the area (block 212). The user may submit the one or more leads through the website 120 or otherwise through a computerized system, such as registration system 110, as described above. Alternatively, the one or more leads may be manually submitted at a reward program office. The method 200 may include transmitting submitted leads to the government, agency or contractor administering the rewards program. Optionally, when a new lead is received, the method 200 may include sending a message to government, agency or contractor administering the rewards program that the user has submitted or filed a new lead. The method 200 may include recording the date and time of when the user submits a lead, as well as all activities the user has with the rewards system.

The method 200 may evaluate the new leads to determine if they meet a qualifying lead criterion established in the business growth incentive program (block 214). The qualifying lead criterion may be set forth in the rules 134. A lead may be processed by a computerized system, such as registration system 110, to determine if the lead meets reward program requirements for being a qualifying lead. Alternatively, a system user or other individual (e.g., employee of government agency or contractor administering the reward program) may examine the leads manually, or with the use of a computerized system such as registration system 110, to determine if the lead is a qualifying lead. For example, the qualifying lead criterion may be that the lead must include information on a business seriously looking for an area in which to move or to expand. This may be determined by evidence (e.g., news releases, press conferences, news articles) indicating that the company is looking to expand or relocate. Likewise, meeting the qualifying lead criterion may be determined by evidence, which may be submitted by the user, indicating that a meeting about moving to or expanding into the area has been held with decision-makers of the business referenced by the lead. Accordingly, determining that a qualifying lead criterion is met may not be determined until some time substantially after the lead is submitted. Indeed, under some criterion, determining that a lead is a qualifying lead may not be possible until after a business has agreed to move or expand (e.g., by signing a contract) or even has successfully moved to or expanded in the area. If the lead is determined to be a qualifying lead, i.e., a qualifying lead criterion is met, the method 200 may calculate a tip to be paid to the user for the lead.

With continued reference to FIG. 2, the development of the new lead may be monitored to determine if a reward payment criterion is met (block 216). The reward payment criterion may be set forth in the rules 134. The lead development may be monitored by a computerized system, such as registration system 110 and/or rewards calculation system 150, as described above. Alternatively, the monitoring 216 may be performed manually, e.g., by a government or contractor employee. The development of a lead is the process by which a lead is developed into a new or expanded business for an area, e.g., through meetings, negotiations, agreements, etc. with the entity referenced by the lead. The reward payment criterion may be the start of a new business in the area, the addition of new jobs in the area, the expansion of an existing business and creation of additional jobs in the area, and the relocation of an out-of-area business to the area. Accordingly, the method 200 may include monitoring 216 the lead development to determine if the lead results in or leads to a new or an expanded business in the area, new jobs in the area, etc. The reward payment criterion may also require that the user establish that he or she is the first that submitted the lead.

The monitoring 216 may include receiving input from a user indicating or evidencing the successful opening or expansion of a business related to a lead. The monitoring step may include receiving input from a government or contractor employee that indicates or evidences the successful opening or expansion of a business related to a lead. For example, a government tax agency may provide information indicating the payment of taxes by a new business, thereby indicating that the business is opened and operating. Other information, as would be apparent to one of skill in the art, may be input to indicate or evidence that the reward payment criterion has been met. The method 200 may receive from the user input and update of the names of new businesses and of individuals in the new businesses whom the user knows or is dealing with, contact information, correspondences, documented evidence that are relevant in determining that the user is responsible for or key to introducing or bringing the new business to the area, a log of progress made in efforts to attract the new businesses, and evidence that helps the user to be eligible for receiving the results-based reward.

Additionally, the monitoring 216 may include a computerized system, such as registration system 110 and/or rewards calculation system 150, automatically monitoring and determining if reward payment criterion has been met. For example, the computerized system may be integrated with a government computerized system, such as a computerized tax system, so that the computerized system may automatically access and periodically check the government system to determine if reward payment criterion has been met.

With continued reference to FIG. 2, if the reward payment criterion is met, the method 200 calculates a results-based reward to be paid to the user (block 218). The results-based reward may be calculated by a computerized system, such as rewards calculation system 150, as described above, or by manual means (e.g., such as by a person using a calculator, pencil, pen, paper, etc.). The rewards may be structured as described above. For example, the results-based reward may be structured as incremental rewards to be paid after different years of operation of the new business. Additionally or alternatively, rewards may paid out after different development phases of a new business (e.g., leasing space for the business, hiring employees, manufacturing products). The results-based reward may be paid out of new tax revenues received by the government. The method 200 may integrate with existing government systems to monitor and track data and parameters that the government has set to govern rewards so as to calculate and administer rewards payable.

The method 200 may also include paying the calculated reward. The results-based reward may be paid to the user using a check or a direct deposit to the user's bank account, or other electronic transfer. When a reward is paid to a user, the reward program administrator may advertise the reward payment to further draw attention to the reward program and to encourage more people to participate.

The method 200 or portions thereof may be repeated for other users and other leads submitted in the reward program. The method ends at block 220.

With reference to FIG. 3, shown is an exemplary advertisement 112 that may be used to engage people in the reward program. The advertisement 112 includes examples of rewards 170 and tips 172 that may be offered in embodiments, as well as statements directing people to get more information by visiting a website 120 for the area.

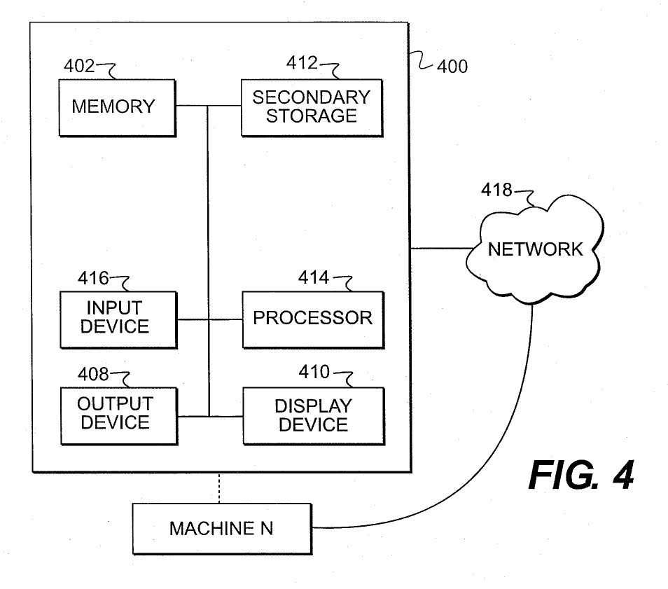

With reference now to FIG. 4, shown are exemplary hardware components of a computer or computer system 400 that may be used in connection with the method for providing a business growth incentive program. The computer 400 includes a connection with the network 418 such as the Internet or other type of computer or telephone network. The computer 400 typically includes a memory 402, a secondary storage device 412, a processor 414, an input device 416, a display device 410, and an output device 408. The computer 400 may be implemented as a server or servers or standalone computer(s).

The memory 402 may include random access memory (RAM) or similar types of memory. The memory 402 may store the necessary data and access other necessary systems to determine if rewards are due, what rewards should be paid and to otherwise track and administer the reward program. Likewise, memory 402 may store one or more applications (e.g., including applications programmed to execute embodiments of methods described herein or embodying systems described herein, as well as to provide web-pages of website 120) for execution by processor 414 or other processor. The secondary storage device 412 may include a hard disk drive, floppy disk drive, CD-ROM drive, flash memory, or other types of non-volatile data storage, and may correspond with various databases or other resources. The processor 414 may execute instructions (e.g., embodied in applications stored in the memory 402) to perform and execute embodiments of the methods described herein. For example, the processor 414 may provide and support the website 120 for the users 140 to submit referral information and to allow the users 140 to access information on the area and the reward program. Also, the processor 414 may enable reward calculation system 150 to monitor the development of the new business leads and to calculate results-based rewards. These instructions may be stored in the memory 402, the secondary storage 412, or received from the Internet or other network 418.

The input device 416 may include any device for entering data into the computer 400, such as a keyboard, keypad, cursor-control device, touch-screen (possibly with a stylus), or microphone. The display device 410 may include any type of device for presenting a visual image, such as, for example, a computer monitor, flat-screen display, or display panel. The output device 408 may include any type of device for presenting data in hard copy format, such as a printer, and other types of output devices including speakers or any device for providing data in audio form. The computer 400 may include multiple input devices, output devices, and display devices.

Computer 400 may store a database structure in secondary storage 412, for example, for storing and maintaining information needed or used by the application(s). Also, processor 414 may execute one or more software applications in order to provide the functions described in this specification, for example, those in the methods described above, and the processing may be implemented in software, such as software modules, for execution by computers or other machines. The processing may provide and support web-pages and other graphical user interfaces (GUIs). The GUIs may be used to enter inputs or view outputs of the systems and methods described herein. The GUIs may be formatted, for example, as web-pages in HyperText Markup Language (HTML), Extensible Markup Language (XML) or in any other suitable form for presentation on a display device.

With continuing reference to FIG. 4, the computer 400 may also include a network adaptor or other connection for connecting computer 400 to the Internet or other network(s) 418. Through network connection computer may connect to the Internet or other network in order to access various other computer systems and databases (e.g., government agency systems and databases), provide and enable access to the website 120, access other websites, etc., for example, and in order to perform the methods described herein.

Although the computer 400 is depicted with various components, one skilled in the art will appreciate that the computer 400 may contain additional or different components. In addition, although aspects of an implementation consistent with the method for providing a business growth incentive program are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling the computer 400 to perform a particular method.

Likewise, although one computer 400 is illustrated herein, multiple computers may be used to implement embodiments of the methods and systems described herein, as indicated by machine N in FIG. 4. For example, different computers 400 may be used to provide registration system and reward calculation system. For example, one or more computers 400 may provide the registration system and one or more computers 400 may provide the reward calculation system. Applications and processing of such instructions to execute and perform methods described herein may be distributed across multiple computers 400. Such computers 400 may be stand-alone workstations and/or servers or network interfaced workstations and/or servers. Other combinations of computers 400 or similar processing devices may be used.

Those skilled in the art may recognize that the reward system and program disclosed herein may be administered in many ways and, for efficiency, may utilize all relevant known methods, things and forms of technology to implement the system, ideas and program disclosed and claimed herein.

While some embodiments have been illustrated and described in relative detail herein, the same is considered to be illustrative and not restrictive in character, it's to be understood that only selected embodiments have been shown and described and that all changes and modifications that may occur within the embodiments described herein are desired to be protected.

The terms and descriptions used herein are set forth by way of illustration only and are not meant as limitations. Those skilled in the art may recognize that many variations are possible within the spirit and scope set forth in the claims, and their equivalents, in which all terms are to be understood in their broadest possible sense unless otherwise indicated. The claims are intended to be exemplary recitations of features of embodiments described herein. Other features and embodiments may be claimed.

What is claimed is:

1. A method for providing a business growth incentive program for an area, the method being implemented using a computer including a processor and a memory, the method comprising:
receiving, using the computer, a user registration for the business growth incentive program;
receiving, using the computer, one or more leads from the user, wherein each lead is for a potential new business, new jobs or expansion of a business for the area;
monitoring a development of the one or more leads to determine if a reward payment criterion is met; and
if the reward payment criterion is met, calculating a reward to be paid to the user.

2. The method of claim 1, wherein the monitoring includes receiving input from a registered user indicating the successful establishment of a new business or new jobs referenced in a lead.

3. The method of claim 1, wherein the monitoring includes receiving an input from a government agency indicating a payment of tax by a new business.

4. The method of claim 1 further comprising evaluating the one or more new business leads to determine if each business lead meets a qualified lead criterion established by the business growth incentive program.

5. The method of claim 4 wherein the qualified lead criterion requires that a lead include information on a company looking for an area to move to, start up or expand in.

6. The method of claim 4 further comprising calculating a tip to pay to the user if a lead meets the qualified lead criterion.

7. The method of claim 6 further comprising paying the tip.

8. The method of claim 1, further comprising providing a website for the user to self register using the Internet.

9. The method of claim 1, further comprising sending the one or more leads to an agency of the government.

10. The method of claim 1, further comprising maintaining the confidentiality of the one or more leads.

11. The method of claim 1, further comprising paying the reward.

12. The method of claim 11, wherein paying the reward includes paying the reward as incremental reward payments paid after each development phase of a new business.

13. The method of claim 1, wherein the reward payment criterion includes one or more of a start of a business in the area, an expansion of an existing business and creation of additional jobs in the area, and a relocation of an out-of-area business to the area.

14. The method of claim 1, wherein the reward payment criterion includes that the user establishing that he or she is the first that filed a particular lead.

15. The method of claim 1, further comprising sending an acknowledgement of receipt after receiving registration information from the user.

16. The method of claim 1, further comprising, when a new lead is received, sending a message to an agency of the area's government that the user has submitted or filed the new lead.

17. The method of claim 1, further comprising recording the date and time of:
when the user registers in the business growth incentive program,
when a lead is submitted, and
all activities the user has with a registration system implemented by the business growth incentive program.

18. The method of claim 1, further comprising receiving from the user input and update of one or more of:
names of new businesses and of individuals in the new businesses whom the user knows or is dealing with,
contact information,
correspondences,
documented evidence that are relevant in determining that the user is responsible or key for introducing or bringing the new businesses to the area,
a log of progress made in efforts to attract the new businesses, and
evidence that helps the user to be eligible for receiving the reward.

19. The method of claim 1, further comprising paying a reward out of new tax revenues received by the government.

20. The method of claim 1 wherein the user registration includes an agreement to be bound by rules of the program.

21. The method of claim 1 wherein the user registration includes personally identifiable information.

22. A system for providing a business growth incentive program for an area the system comprising:
a registration system that receives a user registration for the business growth incentive program that pays rewards if a reward-payment criterion is met in order to encourage new business or new jobs in the area, wherein the registration system receives one or more leads from the user, wherein each of the leads is for potential new business or new jobs or expansion of a business for the area.

23. The system of claim 22 further comprising a reward calculation system that calculates a reward to be paid to the user if a reward payment criterion is met, wherein the reward payment criterion is met if desired new business or new jobs occurs in the area.

24. The system of claim 23 wherein the reward calculation system determines if a reward payment criterion is met.

25. The system of claim 23 wherein the reward calculation system monitors a development of the one or more new leads to determine if a reward payment criterion is met.

26. The system of claim 23 wherein the reward calculation system receives input from a registered user indicating the satisfaction of the reward payment criterion.

27. The system of claim 26 wherein the input includes information indicating the establishment of a new business or new jobs related to one of the leads that was entered in the system for the area.

28. The system of claim 23, wherein the reward calculation system receives an input from a government agency indicating the satisfaction of the reward payment criterion.

29. The system of claim 28 wherein the input indicates the payment of tax by a new business.

30. The system of claim 22 wherein the registration system evaluates the one or more new business leads to determine if they meet a qualified lead criterion established in the business growth incentive program.

31. The system of claim 30 wherein the registration system evaluates the one or more business leads based on the input of a system user.

32. The system of claim 30, wherein the qualified lead criterion requires that the lead includes information on a company seriously looking for an area to move to or expand in.

33. The system of claim 22 further comprising a database that stores information on the business growth incentive program and rules associated with the business growth incentive program.

34. The system of claim 33 wherein the database further stores information on training courses for users, general information about an area, and information on other economic or job growth incentives offered by the area or the government.

35. The system of claim 22, wherein the registration system sends or provides other access to the one or more new business leads to an agency of the area's government.

36. The system of claim 23, wherein the reward payment criterion includes one or more of a start of a business in the area, an expansion of an existing business and creation of additional jobs in the area, and a relocation of an out-of-area business to the area.

37. The system of claim 22, wherein the registration system records the date and time of:
when the user registers in the business growth incentive program,
when data is input and
all activities the user has with the registration system.

38. The system of claim 22 wherein the registration system provides appropriate levels of security and prevents unauthorized access to the registration system and the reward calculation system.

39. The system of claim 23, wherein the reward calculation system is integrated with existing government systems to monitor and track data and parameters that the government has set to govern rewards so as to calculate and administer rewards payable.

40. The system of claim 22 wherein the system further provides a website that enables users to access the registration system.

41. The system of claim 22 comprising a computer including a processor and a memory connected to a network, wherein the registration system resides on and is implemented by the computer.

42. A computer readable medium providing a business growth incentive program for an area, the instructions being executed on a computer including a processor and a memory and comprising:
receiving, using the computer, a user registration for the business growth incentive program;
receiving, using the computer, one or more new business leads from the user, wherein the one or more business leads are for a new business, new jobs or expansion of a business for the area;
evaluating the one or more new business leads to determine if they meet a first criterion established in the business growth incentive program;
if the first criterion is met, monitoring, using the computer, a development of the one or more new business leads to determine if the development meets a second criterion; and
if the second criterion is met, calculating, using the computer, a reward to be paid to the user.
